(19) United States
(12) Patent Application Publication
(10) Pub. No.: US 2021/0146227 A1
(43) Pub. Date: May 20, 2021

(54) ADDITIVELY MANUFACTURED, VENTILATED AND CUSTOMIZED, PROTECTIVE CRICKET GLOVE

(71) Applicant: Carbon, Inc., Redwood City, CA (US)

(72) Inventor: Rishikesh S. Bhagwat, San Carlos, CA (US)

(21) Appl. No.: 17/066,548

(22) Filed: Oct. 9, 2020

Related U.S. Application Data
(60) Provisional application No. 62/935,409, filed on Nov. 14, 2019.

(51) Int. Cl. A63B 71/14; A41D 13/08; A41D 13/015; A41D 19/015; A41D 19/04; B33Y 80/00

(52) U.S. Cl. CPC A63B 71/148; A41D 13/087; A41D 13/082; A63B 2102/20; A41D 19/01523; A41D 19/04; B33Y 80/00; A41D 13/0158

(57) ABSTRACT

The present disclosure describes a a protective glove for a human hand including a glove body comprised of flexible sheet material and configured to overlie the thumb, the second, third, fourth, and fifth digits, the back of the palm, and the knife edge of the hand of a wearer; for each of the second, third, fourth, and fifth digits, at least one elongate flexible lattice cushion connected to the glove body and overlying the dorsal surface of each digit; and at least one planar flexible lattice cushion configured to overlie the dorsal aspect of the palm.

### RELATED APPLICATION(S)

The present application claims priority from and the benefit of U.S. Provisional Application Ser. No. 62/935,409, filed Nov. 14, 2019, the disclosure of which is hereby incorporated herein in its entirety.

### FIELD OF THE INVENTION

Cushioning pad sets for incorporation into protective gloves for cricket batsmen and the like are described, along with methods of making the same.

### BACKGROUND OF THE INVENTION

Protective gloves are used in a variety of sports and occupations to prevent injury to the delicate bones of the hand. See, e.g., U.S. Pat. Nos. 4,748,690; 5,640,712; 7,389,545; and 9,352,211. In the sport of cricket, a batsman's hands are positioned in the cricket bat as shown in FIG. 1. While some parts of the hands are positioned behind the bat, other parts of the hands are exposed. Because cricket balls are hard, pitched fast, and bounce once before reaching the batsman (making their path of travel difficult to anticipate), the batsman's hands are particularly vulnerable to injury, and many players wear protective gloves at this time. These gloves, however, can be hot and ill-fitting, and there is a need for new approaches to glove construction that allow for a better air circulation and a more comfortable fit.

### SUMMARY OF THE INVENTION

A protective glove for a human hand (for example, for use during a sport such as cricket), is described. The glove can include:

(a) a glove body including flexible sheet material and configured to overlie the thumb, the second, third, fourth, and fifth digits of the hand, the back of the palm of the hand, and the knife edge of the hand of a wearer;

(b) for each of the second, third, fourth, and fifth digits, at least one elongate flexible lattice cushion connected to the glove body and overlying the dorsal surface of each digit;

(c) at least one planar flexible lattice cushion configured to overlie the dorsal aspect of the palm;

(d) optionally, but in some embodiments preferably, an elongate flexible polymer lattice cushion configured to overlie the knife edge of the hand;

(e) optionally, but in some embodiments preferably, at least one flexible lattice cushion configured to overlie the dorsal surface of the thumb.

Depending on the purpose of the glove, and the hand (right or left) for which the glove is constructed, the glove can optionally contain at least one of (d) or (e). In some embodiments, the glove contains both of (d) and (e), while in other embodiments discussed further below, the glove contains only one, but not the other, of (d) and (e).

The lattice cushions are preferably made by additive manufacturing, such as by top-down or bottom-up stereolithography (for example, continuous liquid interface production or “CLIP”).

In some embodiments, each of the lattice cushions is comprised of a flexible or elastic polymer (e.g., a polyurethane polymer, a polyurea polymer, or a combination thereof).

Pairs of protective gloves as described above are also described herein, particularly those with complimentary features suited to protecting a cricket batsmen's hands.

The foregoing and other objects and aspects of the present invention are explained in greater detail in the drawings herein and the specification set forth below. The disclosures of all United States patent references cited herein are to be incorporated herein by reference.

### BRIEF DESCRIPTION OF THE DRAWINGS

FIG. 1 shows a right-handed cricket batsman gripping a bat as the batsman may face the bowler (pitcher).

FIG. 2L shows the bones of a human left hand, when viewed from above, with the palm down.

FIG. 2R shows the bones of a human right hand, when viewed from above with the palm facing down.

FIG. 3L is similar to FIG. 2L, except that a set of protective cushions are shown schematically, by dotted lines, on the back surface of the hand.

FIG. 3R is similar to FIG. 2R, except that a set of protective cushions are shown schematically, by dotted lines, on the back surface of the hand.

FIG. 4A schematically illustrates how a complete set of protective cushions in FIG. 3L and FIG. 3R may be arranged on the carrier platform of a bottom-up or top-down additive manufacturing apparatus for production thereon.

FIG. 4B is a perspective view showing a partial set of protective cushions on the carrier platform of a bottom-up additive manufacturing apparatus for production thereon.

FIG. 5A is a perspective view of the top surface of a protective cushion for an index or second finger (e.g., 12 or 12′).

FIG. 5B is similar to FIG. 5A, except that the orientation of the cushion has been reversed so that the bottom surface is visible.

FIG. 6A is a schematic, side sectional view showing a first example of how a protective cushion as described herein may be secured to a glove body as described herein.

FIG. 6B is a schematic, side sectional view showing a second example of how a protective cushion as described herein may be secured to a glove body as described herein.

FIG. 6C is a schematic, side sectional view showing a third example of how a protective cushion as described herein may be secured to a glove body as described herein.

FIG. 6D is a schematic, side sectional view showing how a protective cushion may be configured to resiliently engage the finger of a wearer.

### DETAILED DESCRIPTION OF ILLUSTRATIVE EMBODIMENTS

The present invention is now described more fully hereinafter with reference to the accompanying drawings, in which embodiments of the invention are shown. This invention may, however, be embodied in many different forms and should not be construed as limited to the embodiments set forth herein; rather these embodiments are provided so that this disclosure will be thorough and complete and will fully convey the scope of the invention to those skilled in the art.

As used herein, the term “and/or” includes any and all possible combinations of one or more of the associated listed items, as well as the lack of combinations when interpreted in the alternative (“or”).

1. Additive manufacturing of Protective Cushions

While the cushions described herein can be made with any suitable resin, dual cure resins are currently preferred for carrying out the present invention. Such resins are known and described in, for example, U.S. Pat. Nos. 9,676,963, 9,453,142 and 9,598,606 to Rolland et al. Particular examples of suitable dual cure resins include, but are not limited to, Carbon Inc. elastomeric polyurethane or flexible polyurethane dual cure resins, all available from Carbon, Inc., 1089 Mills Way, Redwood City, Calif. 94063 USA.

Techniques for producing an intermediate object, or “green” intermediate, from such resins by additive manufacturing are known. Suitable techniques include bottom-up and top-down additive manufacturing, generally known as stereolithography. Such methods are known and described in, for example, U.S. Pat. No. 5,236,637 to Hull, U.S. Pat. Nos. 5,391,072 and 5,529,473 to Lawton, U.S. Pat. No. 7,438,846 to John, U.S. Pat. No. 7,892,474 to Shkolnik, U.S. Pat. No. 8,110,135 to El-Siblani, U.S. Patent Application Publication No. 2013/0292862 to Joyce, and U.S. Patent Application Publication No. 2013/0295212 to Chen et al. The disclosures of these patents and applications are incorporated by reference herein in their entirety.

In some embodiments, the additive manufacturing step is carried out by one of the family of methods sometimes referred to as continuous liquid interface production (“CLIP”). CLIP is known and described in, for example, U.S. Pat. Nos. 9,211,678; 9,205,601; 9,216,546; and others; in J. Tumbleston et al., Continuous liquid interface production of 3D Objects, Science 347, 1349-1352 (2015); and in R. Janusziewcz et al., Layerless fabrication with continuous liquid interface production, Proc. Natl. Acad. Sci. USA 113, 11703-11708 (Oct. 18, 2016). Other examples of methods and apparatus for carrying out particular embodiments of suitable methods of making include, but are not limited to: Batchelder et al., U.S. Patent Application Publication No. 2017/0129169 (May 11, 2017); Sun and Lichkus, U.S. Patent Application Publication No. 2016/0288376 (Oct. 6, 2016); Willis et al., U.S. Patent Application Publication No. 2015/0360419 (Dec. 17, 2015); Lin et al., U.S. Patent Application Publication No. 2015/0331402 (Nov. 19, 2015); D. Castanon, U.S. Patent Application Publication No. 2017/0129167 (May 11, 2017); L. Robeson et al., PCT Patent Publication No. WO2015/164234 (see also U.S. Pat. Nos. 10,259,171 and 10,434,704 C Mirkin et al., PCT Patent Publication No. WO2017/210298 (see also U.S. Patent Application Publication No. 2019/0160733); B. Feller, U.S. Patent Application Publication No. 2018/0243976 (Aug. 30, 2018); M. Panzer and J. Tumbleston, U.S. Patent Application Publication No. 2018/0126630 (May 10, 2018); and K. Willis and B. Adzima, U.S. Patent Application Publication No. 2018/0290374 (Oct. 11, 2018).

Once the intermediate object has been formed and optionally cleaned (e.g., by wiping, blowing, spinning, washing, etc.), the object is then further cured, such as by heating. Heating may be active heating (e.g., baking in an oven, such as an electric, gas, solar oven or microwave oven, or combination thereof), or passive heating (e.g., at ambient (room) temperature). Active heating will generally be more rapid than passive heating and is typically preferred, but passive heating—such as simply maintaining the intermediate at ambient temperature for a sufficient time to effect further cure—may in some embodiments also be employed.

### 2. Protective Cushions and Gloves

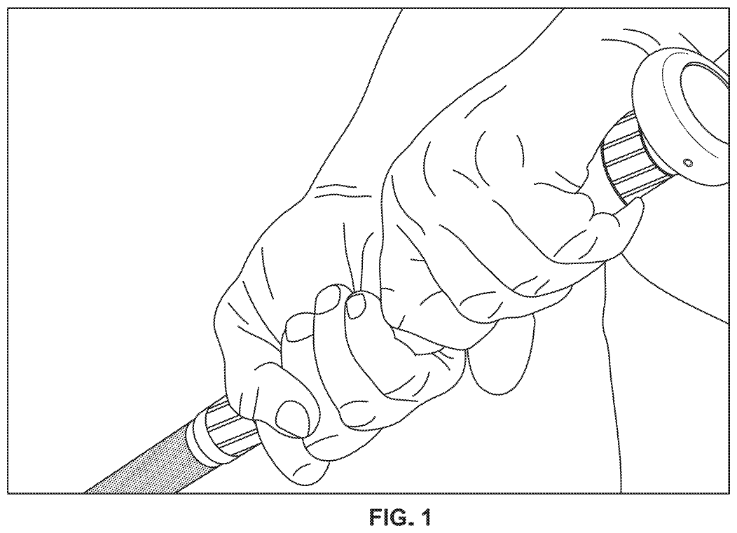

The positioning of a right-handed cricket batsman's hands is discussed above in connection with FIG. 1. Certain bones of the hand are vulnerable to being broken by the bowled cricket ball and are preferably protected by cushions as described herein, secured in or on a glove, as described herein.

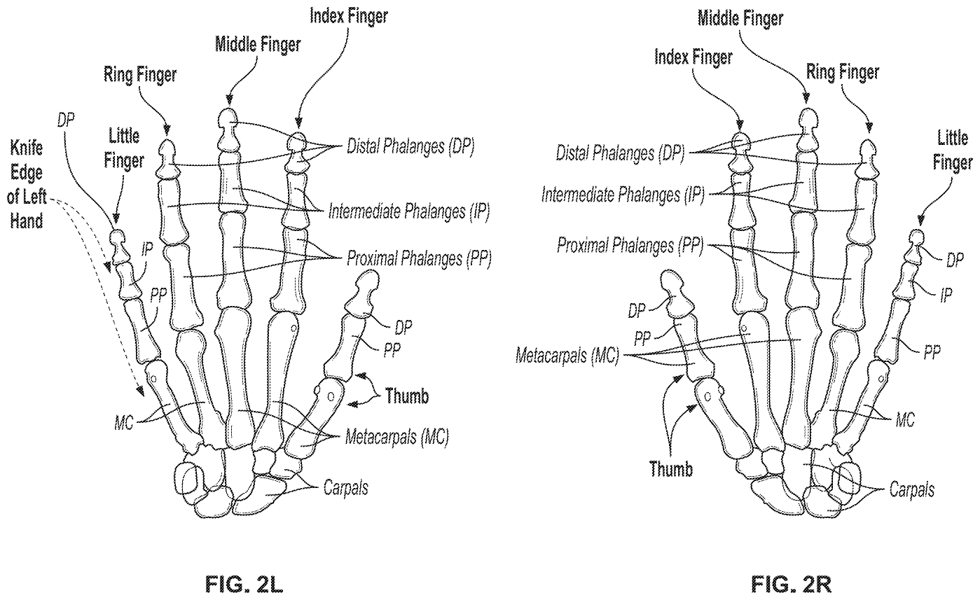

For the purpose of orientation, the bones of a pair of human hands are shown in FIG. 2L and FIG. 2R, where the hands are positioned palms facing down, and hence viewed from the dorsal surface or aspect (that is, the back of the hand). Each hand includes a thumb (first digit), index finger (second digit), middle finger (third digit), ring finger (fourth digit) and little finger or “pinky” finger (fifth digit). Each of the second, third, fourth, and fifth digits includes a proximal, intermediate, and distal phalange. The thumb includes a proximal and distal phalange (but no intermediate phalange). Each of the five digits has a corresponding metacarpal bone, located in the palm of the hand. Each hand has a “knife edge” on the side edge of the hand, extending from the distal tip of the fifth digit down along the side of the hand to the base of the palm and wrist, where the carpal bones are contained. The protective glove may be secured to the hand of the wearer by any suitable means, such as by inclusion of a strap assembly (for example, a hook-and-loop fastener strap assembly) overlying the wrist of the wearer.

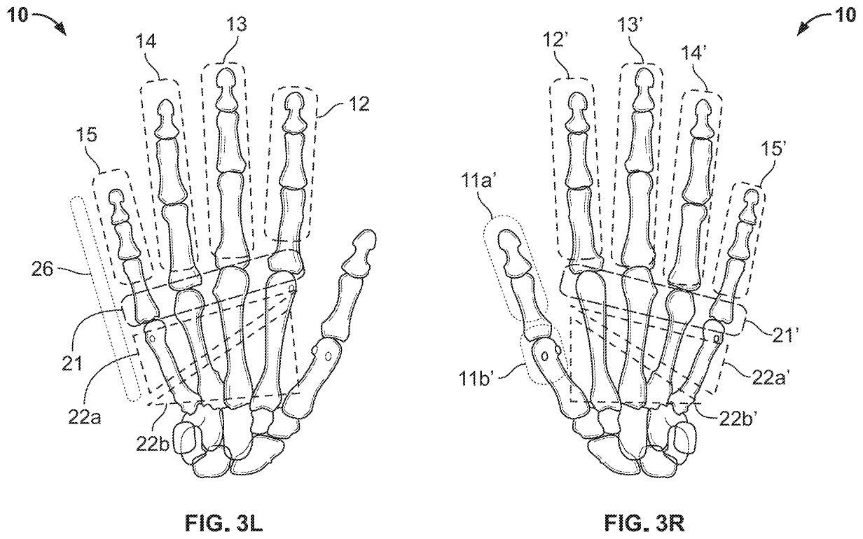

From FIGS. 1, 2L, and 2R, the arrangement of flexible lattice cushions (12, 13, 14, 15, 12′, 13′, 14′, 15′, 21, 22a, 22b, 21′, 22a′, 22b′) in a protective glove 10 for a human hand, such as for use during a sport like cricket, can be seen, and is initially illustrated in FIGS. 3L and 3R. The protective glove (10) may include a glove body (10b) (discussed further below) including flexible sheet material and configured to overlie the thumb, the second, third, fourth, and fifth digits of the hand, the back of the palm of the hand, and the knife edge of the hand of a wearer. For each of the second, third, fourth, and fifth digits, at least one elongate flexible lattice cushion (12, 13, 14, 15, 12′, 13′, 14′, 15′) may be connected to the glove body (10b) and overlie the dorsal surface of each digit. Preferably, the elongate flexible lattice cushion(s) (12, 13, 14, 15, 12′, 13′, 14′, 15′) is configured to protect the distal, intermediate, and proximal phalanges of each digit therein. For example, as shown in the overlie of the bones of the hand in the figures. In some embodiments, at least one planar flexible lattice cushion (21, 22a, 22b, 21′, 22a′, 22b′) may be configured to overlie the dorsal aspect of the palm. Preferably, at least one planar flexible lattice cushion (21, 22a, 22b, 21′, 22a′, 22b′) is configured to protect the metacarpals therein.

Optionally, but in some embodiments preferably, one, or at least one, elongate flexible polymer lattice cushion (26) is configured to overlie the knife edge of the hand. Preferably, the elongate flexible polymer lattice cushion (26) is configured to protect the distal, intermediate, and proximal phalanges, and metacarpals, therein. Also, optionally, but in some embodiments preferably, at least one flexible lattice cushion (11a′, 11b') is configured to overlie the dorsal surface of the thumb. Preferably, the at least one flexible lattice cushion (11a′, 11b′) is configured to protect the distal and proximal phalanges therein.

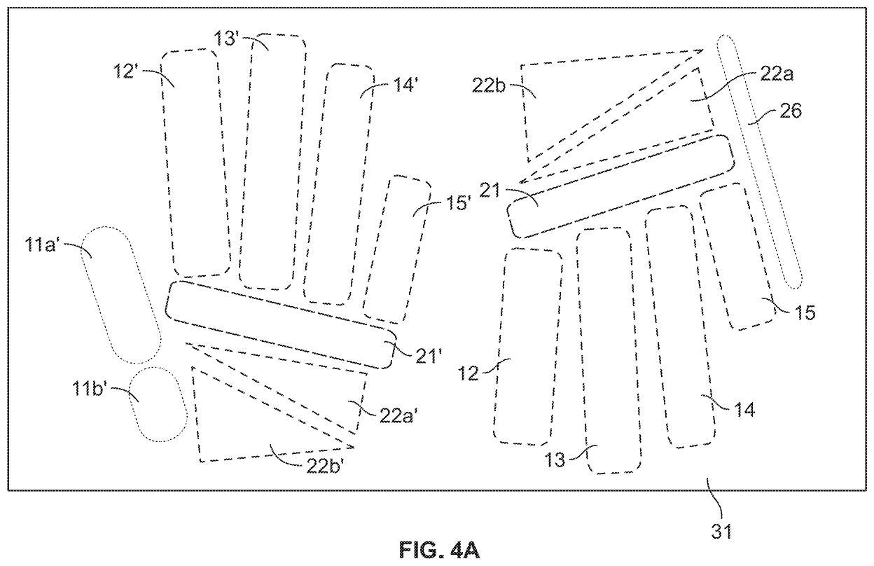

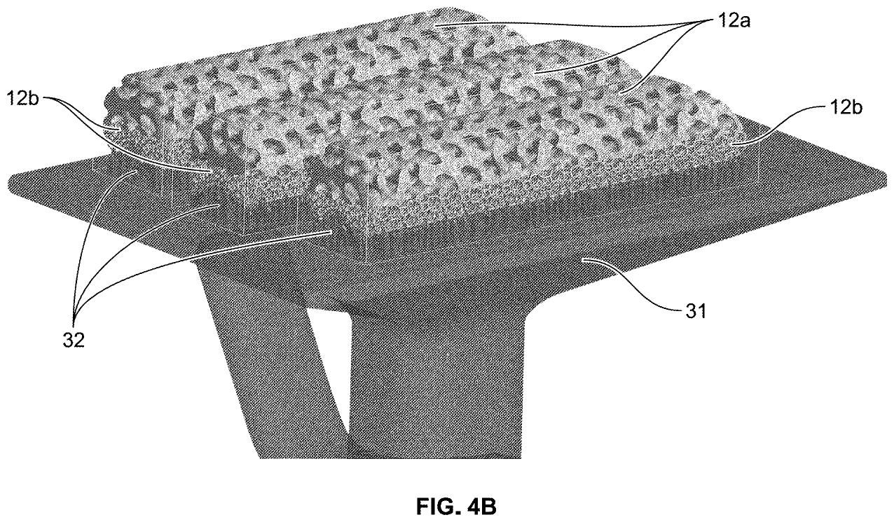

Although not essential, in some embodiments, all the cushions for a particular glove (10) or pair of gloves (10) can be produced on the carrier platform (31) of a bottom-up or top-down stereolithography apparatus, such as shown in FIG. 4A (where numbering of individual cushions is the same as given in FIGS. 3L-3R). In some embodiments, a subet of lattice cushions can be produced on the carrier platform (31), such as shown in FIG. 4B. The lattice cushions may be formed directly on the platform (31), or in some embodiments formed on supports (32) as shown in FIG. 4B. In some embodiments, the lattice cushions are produced from a light-polymerizable resin (e.g., a dual-cure resin). In the case shown in FIG. 4A, all of the lattice cushions are necessarily formed from the same resin; in the case shown in FIG. 4B, the lattice cushions can optionally be formed from the same resin (as different cushions can be printed at different times or on different machines, from different resins, if desired). In some embodiments, the lattice cushions may be comprised of a flexible or elastic polymer, for example, a polyurethane polymer, a polyuria polymer, or a combination thereof.

While not shown, in some embodiments, each of the lattice cushions can include a distinct printed indicia indicating glove position for the cushion, and optionally indicating either a specific glove size (e.g., extra-small, small, medium, large, extra large, etc.) or a specific individual wearer for the glove (10) (e.g., a custom made-to-measure lattice cushion set for a custom or “bespoke” glove). Such indicia can be added to the data file from which the lattice cushions are produced during additive manufacturing in accordance with known techniques or variations thereof that will be apparent to those skilled in the art.

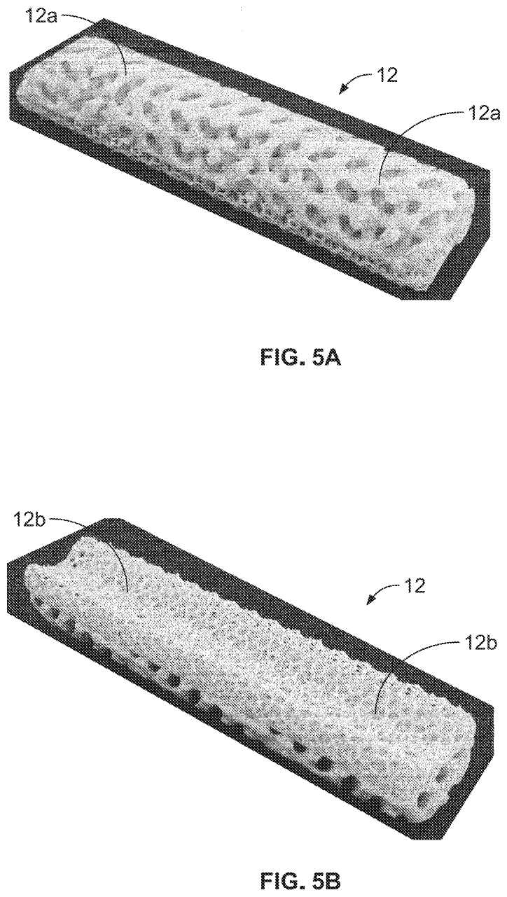

As also shown in FIG. 4B, and then more clearly in FIGS. 5A-5B, in some embodiments, the elongate flexible lattice cushions for each of the second, third, fourth, and fifth digits (illustrated for example by cushion 12), is a composite lattice comprised of (i) an inner-facing, wearer conformable, comfort lattice (12b), and (ii) an outer-facing, shock absorbing, protective lattice (12a). In some embodiments, the comfort lattice (12b) has a concave inner surface configured so that the cushion (12) at least partially surrounds the corresponding digit of a wearer. Cushions for the back of the palm, knife edge, and thumb may optionally, but in some embodiments preferably, also may be composite lattices including such a conformable comfort lattice (12b) and an outer facing protective lattice (12a). Any suitable construction of the composite lattice may be employed, but in some embodiments the comfort lattice is comprised of an interconnected strut lattice (as illustrated in FIGS. 5A-5B); and the protective lattice is comprised of either an interconnected strut lattice (as illustrated in FIGS. 5A-5B) or a surface lattice (not shown, but for example, a Schwarz-P lattice, an R-FD lattice, etc).

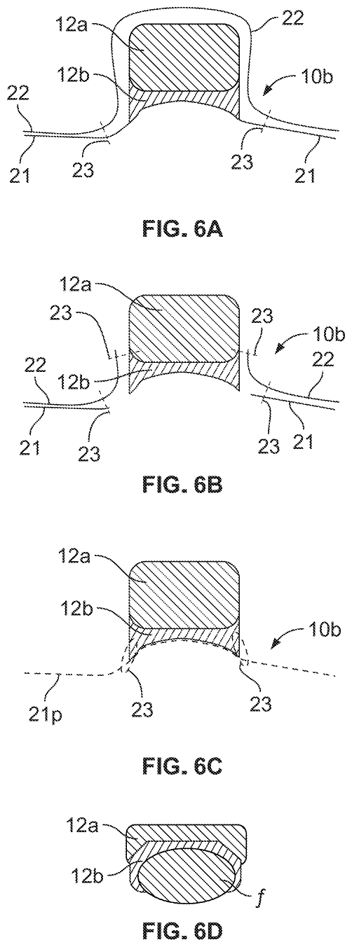

As noted above, the glove body (10b) may be formed of one or more flexible sheet materials in accordance with known techniques. The flexible sheet material can be a natural or synthetic fabric, a natural or synthetic leather, or a combination thereof (where natural leather may be an animal hide-based leather or a vegan leather such as MYLO™ or MUSKIN™ mushroom-based vegan leather). In some embodiments, a plurality, or a majority, of the lattice cushions may be joined to one another by flexible connector elements or tendons. These flexible connector elements may be produced concurrently with the cushions during additive manufacturing thereof. For example, as shown in FIG. 6A, the glove body (10b) may comprise a liner portion (21), an shell portion (22), and stitching or other fastening (23) securing the two together, the lattice cushion contained therein with the comfort lattice facing (12b) the wearer, and the protective lattice (12a) facing away from the wearer. The liner (21) need not totally enclose the hand of the wearer and the shell portion need not totally enclose the liner portion (21), but can be segmented or merge in function depending on the region of the hand underlying the glove (10), as is known in the art of glove design.

In some embodiments, the glove body (10b) has pores and/or openings formed therein, the pores and/or openings may be positioned to facilitate ventilation of the glove through at least some of the lattice cushions. For example, as schematically illustrated in FIG. 6B, the glove liner and glove shell may have substantial openings formed therein so that air may directly flow from the exterior of the glove to the skin of a wearer. Alternatively, as schematically illustrated in FIG. 6C, the glove body (10b) may be formed of a single sheet material (21p) which is sufficiently porous to allow air circulation, and/or moisture wicking, through the material and enhance ventilation to the skin of a wearer. Numerous additional configurations can readily be envisioned. For example, as schematically illustrated in FIG. 6D, in some embodiments, the comfort lattice (12b) surrounds a major portion of the corresponding digit of a wearer, and resiliently engages the finger (f) of a wearer. This construction may provide a preferred means of securing portions of the glove (10) to individual digits of the wearer, and/or enhance the protection of the engaged digit to impact injury. In some cases, this may entirely obviate the need for a glove body (10b), at least for the particular portion of the hand and/or digits so engaged.

While individual gloves (10) are described above, it will be appreciated that pairs of protective gloves (10) are also described herein, each individual glove (10) as described herein, with one configured for the left hand of a wearer and the other configured for the corresponding right hand of the wearer. In some embodiments of such pairs, such as in gloves (10) for cricket batsmen, a first one of the gloves (10) includes (d) but not (e); and a second one of the gloves (10) includes (e) but not (d). The precise choice will depend upon whether the batsman is left hand or right hand dominant, but FIG. 1 as noted above shows a right-handed cricket batsman, and the figures herein show the arrangement for cushions in gloves (10) configured for a right-handed batsman.

While cushions are shown as discrete components herein, some or all can optionally be joined together during additive manufacturing thereof by connectors such as tendons, which connectors can be used to facilitate the installation of the cushions into a glove body (10b). The connectors or tendons can be retained intact in the finished glove, or severed just before or after installation into the glove (10).

Also, while cushions for the second through fifth digits, and the knife edge of the hand, are shown herein as single cushions, it will be appreciated that these cushions can be subdivided into two or more segments, optionally joined by connectors or tendons as described above. Conversely, while cushions shown for the thumb, and for the dorsal surface of the palm, are shown as two cushions, these can be further subdivided, or consolidated as a single cushion.

In some embodiments, the protective glove (10) of the present invention includes a pocket that is configured to fit two or more fingers. For example, in some embodiments, the middle, ring, and pinky fingers (i.e., the third, fourth, and fifth digits) may be grouped into one pocket in the glove with the index finger and the thumb being free from the pocket. The pocket has a flexible lattice cushion configured to overlie the dorsal surface of the fingers grouped in the pocket. Optionally, the index finger and the thumb may each have a flexible lattice cushion configured to overlie the dorsal surface of the index finger and/or thumb. In some embodiments, the pocket may be configured to fit four fingers (i.e., the second, third, fourth, and fifth digits) with the thumb being free from the pocket, e.g., resembling a mitten or boxing glove.

Embodiments of the present invention may be used in other activities where individuals are concerned about protecting their hands/fingers from crushing and/or impact injuries. For example, in some embodiments, the protective glove (10) of the present invention may be used as a batter's glove in baseball. Additional sports that the protective glove (10) of the present invention may be used include, but are not limited to, ice hockey, lacrosse, skiing, mixed-martial arts, boxing, and motor-cross.

The foregoing is illustrative of the present invention, and is not to be construed as limiting thereof. The invention is defined by the following claims, with equivalents of the claims to be included therein.

We claim:

1. A protective glove for a human hand, comprising:
(a) a glove body comprised of flexible sheet material and configured to overlie the thumb, the second, third, fourth, and fifth digits, the back of the palm, and the knife edge of the hand of a wearer;
(b) for each of the second, third, fourth, and fifth digits, at least one elongate flexible lattice cushion connected to said glove body and overlying the dorsal surface of each digit;
(c) at least one planar flexible lattice cushion configured to overlie the dorsal aspect of the palm;
(d) optionally, but in some embodiments preferably, an elongate flexible polymer lattice cushion configured to overlie the knife edge of the hand;
(e) optionally, but in some embodiments preferably, at least one flexible lattice cushion configured to overlie the dorsal surface of the thumb.

2. The protective glove of claim 1, wherein each of said at least one elongate flexible lattice cushions for each of the second, third, fourth, and fifth digits, is a composite lattice comprised of:
(i) an inner-facing, wearer conformable, comfort lattice, and
(ii) an outer-facing, shock absorbing, protective lattice.

3. The protective glove of claim 2, wherein said comfort lattice includes a concave inner surface configured so that said cushion at least partially surrounds the corresponding digit of a wearer.

4. The protective glove of claim 3, wherein said comfort lattice surrounds a major portion of the corresponding digit of a wearer, and resiliently engages the finger of a wearer.

5. The protective glove of claim 2, wherein:
said comfort lattice is comprised of an interconnected strut lattice; and
said protective lattice is comprised of either an interconnected strut lattice or a surface lattice.

6. The protective glove of claim 1, wherein each of said lattice cushions is comprised of a flexible or elastic polymer.

7. The protective glove of claim 1, wherein each and all of said lattice cushions are produced by additive manufacturing.

8. The protective glove of claim 5, wherein each of said lattice cushions includes a distinct printed indicia indicating glove position for said cushion, and optionally indicating either a specific glove size or a specific individual wearer for the glove.

9. The protective glove of claim 1, wherein a plurality, or a majority, of said lattice cushions are joined to one another by flexible connector elements or tendons.

10. The protective glove of claim 1, wherein all of said lattice cushions are produced from the same light-polymerizable resin.

11. The protective glove of claim 1, wherein said glove body comprises pores and/or openings formed therein, said pores and/or openings being positioned to facilitate ventilation of the glove through at least some of said lattice cushions.

12. The protective glove of claim 1, wherein said flexible sheet material is comprised of a natural or synthetic fabric, a natural or synthetic leather, or a combination thereof.

13. The protective glove of claim 1, containing at least one of (d) or (e).

14. The protective glove of claim 1, containing only one of (d) or (e).

15. A pair of protective gloves of claim 1, one configured for the left hand of a wearer and the other configured for the corresponding right hand of the wearer.

16. The pair of protective gloves of claim 15, wherein:
a first one of said gloves includes (d) but not (e); and
a second one of said gloves includes (e) but not (d).

17. The pair of protective gloves of claim 16, wherein said gloves are cricket batsman gloves.
